(19) United States
(12) Patent Application Publication
(10) Pub. No.: US 2024/0159359 A1
(43) Pub. Date: May 16, 2024

(54) GAS SUPPLY SYSTEM

(71) Applicant: TOYOTA JIDOSHA KABUSHIKI KAISHA, Toyota-shi (JP)

(72) Inventor: Tomohito ENOKI, Toyota-shi (JP)

(73) Assignee: TOYOTA JIDOSHA KABUSHIKI KAISHA, Toyota-shi (JP)

(21) Appl. No.: 18/473,663

(22) Filed: Sep. 25, 2023

(30) Foreign Application Priority Data
Nov. 10, 2022 (JP) 2022-180342

(51) Int. Cl. F17C 7/04

(52) U.S. Cl. CPC F17C 7/04; F17C 2205/0326; F17C 2205/0352; F17C 2223/0161; F17C 2250/03; F17C 2250/043; F17C 2250/0486; F17C 2250/0636

(57) ABSTRACT

A system for supplying a gas to a supply target from a fluid of a gas-liquid mixture stored in a pressure vessel, comprising: a first line connected to a layer of the gas in the pressure vessel; a second line connected to a layer of the liquid in the pressure vessel and having a vaporizer in the middle and merging into the first line downstream of the vaporizer; a valve disposed between the pressure vessel and the vaporizer in the second line; a pressure gauge for obtaining a pressure in the pressure vessel; and a control device, wherein the control device receives pressure information from the pressure gauge and, when the internal pressure of the pressure vessel falls below a predetermined value, controls to open the valve and supply the vaporized gas in the vaporizer in the second line from the first line to the pressure vessel.

### CROSS-REFERENCE TO RELATED APPLICATION

This application claims priority to Japanese Patent Application No. 2022-180342 filed on Nov. 10, 2022, incorporated herein by reference in its entirety.

### BACKGROUND

### 1. Technical Field

The present disclosure relates to a gas supply system.

### 2. Description of Related Art

Japanese Unexamined Patent Application Publication No. 2004-308844 (JP 2004-308844 A) discloses the installation of a second tank with an adsorbent as a means for effectively using the boil-off gas in a cryogenic tank without discharging the boil-off gas to the outside of the system. JP 2004-308844 A discloses that a back pressure valve is installed between a first tank and the second tank, and the pressure on the first tank side is maintained as high as possible to reduce the amount of the boil-off gas, thereby suppressing the discharge amount of the boil-off gas from the second tank to the atmosphere.

### SUMMARY

However, in the conventional technique described in JP 2004-308844 A, the tank internal pressure changes according to the magnitude of the intrusion heat, and it is difficult to cope with a change in the internal pressure.

In view of the above problems, an object of the present disclosure is to provide a gas supply system capable of adjusting the internal pressure in response to the change in the internal pressure of a pressure vessel.

The present application discloses a gas supply system, and the gas supply system for supplying a gas to a supply target from a gas-liquid mixture fluid stored in a pressure vessel includes:
a first line connected to a layer of the gas in the pressure vessel;
a second line connected to a layer of liquid in the pressure vessel and including a vaporizer in a middle of the second line, and merging into the first line downstream of the vaporizer;
a valve disposed between the pressure vessel and the vaporizer in the second line;
a pressure gauge for obtaining a pressure in the pressure vessel; and
a control device.

The control device receives pressure information from the pressure gauge, and opens the valve and performs control to supply the gas vaporized by the vaporizer in the second line from the first line to the pressure vessel when an internal pressure of the pressure vessel falls below a predetermined value.

Further, the present application discloses a gas supply system, and the gas supply system for supplying a gas to a supply target from a gas-liquid mixture fluid stored in a pressure vessel includes:
a first line connected to a layer of the gas in the pressure vessel;
a second line connected to a layer of liquid in the pressure vessel and including a vaporizer in a middle of the second line, and merging into the first line downstream of the vaporizer;
a valve disposed between the pressure vessel and the vaporizer in the second line;
a pressure gauge for obtaining a pressure in the pressure vessel; and
a control device.

The control device receives pressure information from the pressure gauge, and closes the valve and performs control to supply the gas from the first line to the supply target when an internal pressure of the pressure vessel exceeds a predetermined value.

The gas supply system may be configured such that the first line is also provided with a valve, and opening and closing of the valve is controlled by the control device.

According to the present disclosure, the internal pressure can be adjusted in response to the change in the internal pressure in the pressure vessel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of a configuration of a gas supply system 10;

FIG. 2 is a diagram illustrating a flow of a control S1;

FIG. 3 is a diagram illustrating a flow of a control S10;

FIG. 4 is a diagram illustrating a flow of a control S20;

FIG. 5 is a diagram illustrating a flow of a control S30;

FIG. 6 is a diagram illustrating a flow of a control S40;

FIG. 7 is a flow diagram of a control S101; and

FIG. 8 is a diagram illustrating a flow of a control S110.

### DETAILED DESCRIPTION OF EMBODIMENTS

### 1. Configuration of the Gas Supply System

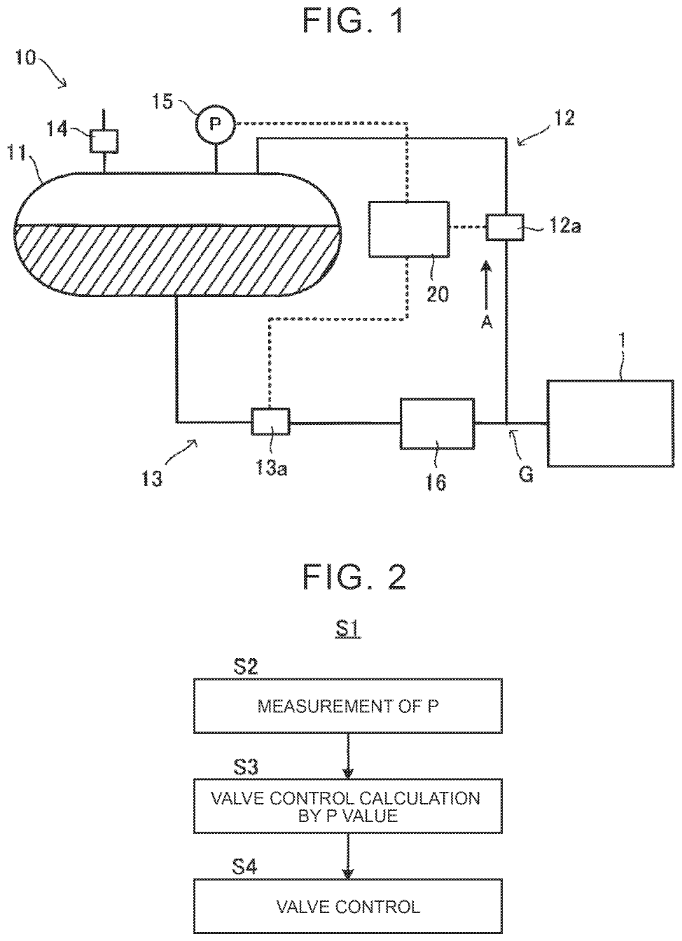

FIG. 1 conceptually illustrates a configuration of a gas supply system 10 according to one embodiment. Such a gas supply system 10 is a system that supplies a cryogenic fluid such as liquid nitrogen or liquid oxygen stored in a pressure vessel in a gas-liquid mixed state to a supply target in a gas state.

The gas supply system 10 comprises a pressure vessel 11. A cryogenic fluid is stored in a gas-liquid mixed state inside the pressure vessel 11. The pressure vessel 11 includes a first line 12 and a second line 13. The first line 12 is a piping system that connects to the gas layer of the stored cryogenic fluid and serves as a flow path for extracting and flowing a gas. The second line 13 is a piping system that is connected to the liquid layer of the stored cryogenic fluid and serves as a flow path through which the cryogenic fluid is taken out in a liquid state and flows. Therefore, the first line 12 is connected to the upper portion of the pressure vessel 11. The second line 13 is connected to the lower portion of the pressure vessel 11. The first line 12 and the second line 13 merge in the middle (portion G) and are connected to the supply target 1.

The pressure vessel 11 is provided with a safety valve 14 for releasing gas from the inside of the pressure vessel 11 and a pressure gauge 15 for obtaining the pressure (internal pressure) inside the pressure vessel 11. The pressure gauge 15 is configured to transmit the measured value as a signal to a control device 20, which will be described later.

In addition, a switching valve 12a for switching between the permission and prohibition of the flow of the fluid is disposed in the first line 12. In the second line 13, a switching valve 13a for switching between the permission and the prohibition of the flow of fluid is arranged in the middle thereof. The switching valve 12a, 13a is a solenoid valve and is configured to be capable of switching between an open state (an allowable state of fluid flow) and a closed state (a prohibited state of fluid flow) upon receiving a signal from a control device 20, which will be described later.

Further, a vaporizer 16 is provided between the switching valve 13a and the merging portion G in the second line 13. The vaporizer 16 is a device that heats and vaporizes a liquid cryogenic fluid flowing in the second line 13. The vaporizer 16 is not particularly limited as long as it can be heated so as to vaporize the liquid flowing in the pipe, and a known vaporizer can be used.

The control device 20 obtains the pressure information from the pressure gauge 15, performs calculation, and issues a command to the switching valve 12a, 13a based on the calculation result, thereby controlling the flow of the fluid and appropriately holding the internal pressure of the pressure vessel 11. Such a control device 20 includes a processor and Central Processing Unit (CPU) a Random Access Memory (RAM) that functions as a working area, a Read-Only Memory (ROM) that functions as a recording medium), a receiving unit that is an interface to which a device is connected and receives information from the device to the control device 20, and a transmitting unit that is an interface that is connected from the device and transmits information to the outside from the control device 20.

The control device 20 stores a program that processes information from each device and determines and operates the operation of the device. In the control device 20, a CPU, RAM and a ROM as hardware resources and programs cooperate with each other. Specifically, a CPU controls a device by executing a computer program recorded in a ROM in a RAM functioning as a working area. The data acquired or generated by CPU is stored in RAM. In addition, a recording medium may be separately provided inside or outside the control device 20, and programs and various data may be recorded therein. Such a control device 20 can typically be constituted by a computer.

### 2. Internal Pressure Control of the Pressure Vessel

As an example, the internal pressure control S1 of the pressure vessel by the gas supply system 10 will be described. This control is performed by the control device 20 calculating the pressure obtained by the pressure gauge 15 and controlling the switching valve 12a, 13a. In FIG. 2, the flow of the pressure vessel internal pressure control S1 is shown.

As a precondition, as the pressure related to the pressure vessel 11, the pressure lower limit specified value shall be Pl, the pressure upper limit specified value shall be Pu, the safety valve set value shall be Ps, and the pressure vessel internal pressure shall be P. Here, Pl is the pressure defined as the minimum required to deliver the gases to the supply target 1. Pu is the maximum pressure that can be tolerated by the pressure vessel 11 (not the pressure of the nature of the pressure vessel 11 to rupture, but the maximum pressure in terms of gas-supply control). Ps is the pressure at which the safety valve 14 operates. These pressures are set to a predetermined value, and the relation of Pl<Pu<Ps is established. P is the pressure in the pressure vessel 11 obtained by the pressure gauge 15, and varies depending on the situation.

As can be seen from FIG. 2, the internal pressure control S1 of the pressure vessel includes the steps of the measurement S2 of P, the valve control calculation P3 based on the P, and the valve control S4.

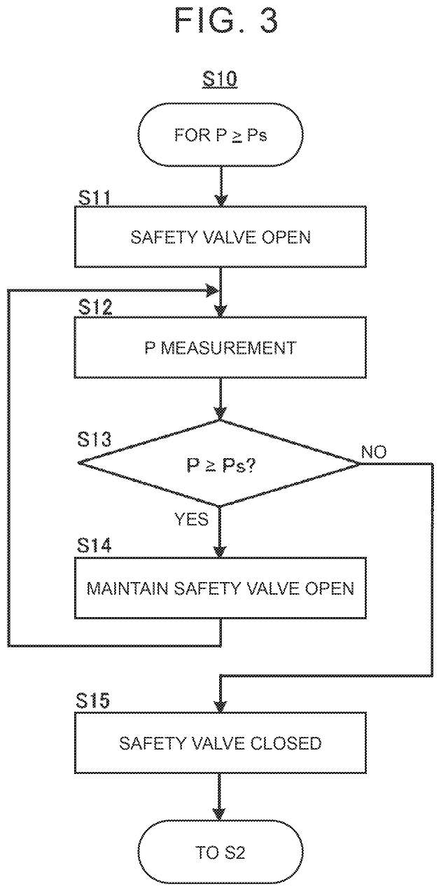

In the measurement S2 of P, an internal pressure of the pressure vessel 11 is obtained by the pressure gauge 15, and the measurement data is signaled to the control device 20. In the valve control calculation S3 based on the value of P, the control device 20 performs calculation based on the pressure value obtained by the measurement S2 of P, thereby determining a command (valve control) for the switching valve 12a, 13a. In the valve control S4, a command is given to the switching valve 12a, 13a based on the P determined by the valve control calculation S3 based on the P. The opening and closing status of the specific switching valve 12a, 13a in the valve control S4 varies depending on the P, and the flow thereof is shown in FIGS. 3 to 6.

### For 2.1.P ≥Ps

If P≥Ps, the control S10 proceeds as shown in FIG. 3. This is when the internal pressure of the pressure vessel 11 is equal to or higher than the operating pressure of the safety valve 14, and the safety valve 14 is opened (process S11), the gas is discharged from the pressure vessel 11, and the internal pressure of the pressure vessel 11 is lowered. Thereafter, P is measured by the pressure gauge 15 again (process S12), and P≥Ps is determined by the control device 20 (process S13). If Yes in the process S13, the internal pressure is still higher, so that the safety valve remains open (process S14) and returns to the process S12. On the other hand, if it is No in the process S13, the internal pressure becomes lower than Ps, so that the safety valve is closed (process S15), and the process returns to the measurement S2 of P.

### When 2.2.Pl≤P≤Pu

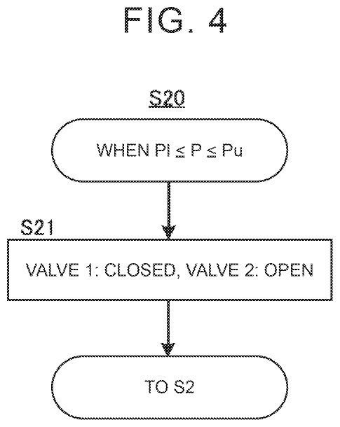

When Pl≤P≤Pu, the control S20 proceeds as shown in FIG. 4. This is the case when the internal pressure of the pressure vessel 11 is between the pressure lower limit specified value Pl and the pressure upper limit specified value Pu, and the internal pressure of the pressure vessel 11 does not need to be positively changed. At this time, the switching valve 12a (valve 1) of the first line 12 is closed, and the switching valve 13a (valve 2) of the second line 13 is opened (process S21). As a result, the fluid in the liquid state flows from the pressure vessel 11 through the second line 13, is vaporized by the vaporizer 16, and is supplied with gas to the supply target 1. Then, the process returns to the measurement S2 of P.

### When 2.3.Pu<P<Ps

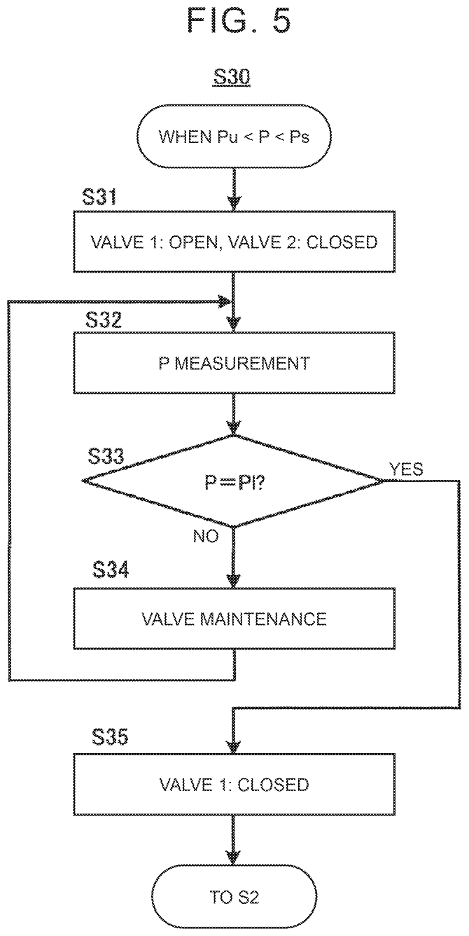

When Pu<P<Ps, the control S30 proceeds as shown in FIG. 5. This is the case when the internal pressure of the pressure vessel 11 has not reached the operating pressure Ps of the safety valve 14 but exceeds the pressure upper limit specified value Pu. At this time, the switching valve 12a of the first line 12 is opened, and the switching valve 13a of the second line 13 is closed (process S31). As a result, the fluid in the gaseous state flows from the pressure vessel 11 through the first line 12, and the gas is supplied to the supply target 1. Therefore, the internal pressure of the pressure vessel 11 is reduced. Thereafter, P is measured by the pressure gauge 15 again (process S32), and the control device 20 determines P=Pl (process S33). If it is No in the process S33, since the internal pressure of the pressure vessel 11 has not reached the pressure lower limit specified value Pl, the switching valve 12a, 13a is maintained in the process S31 (process S34) and returns to the process S32. On the other hand, if it is Yes in the process S33, the internal pressure has reached Pl, so that the switching valve 12a of the first line 12 is closed (process S35), and the process returns to the measurement S2 of P.

### For 2.4.P<Pl

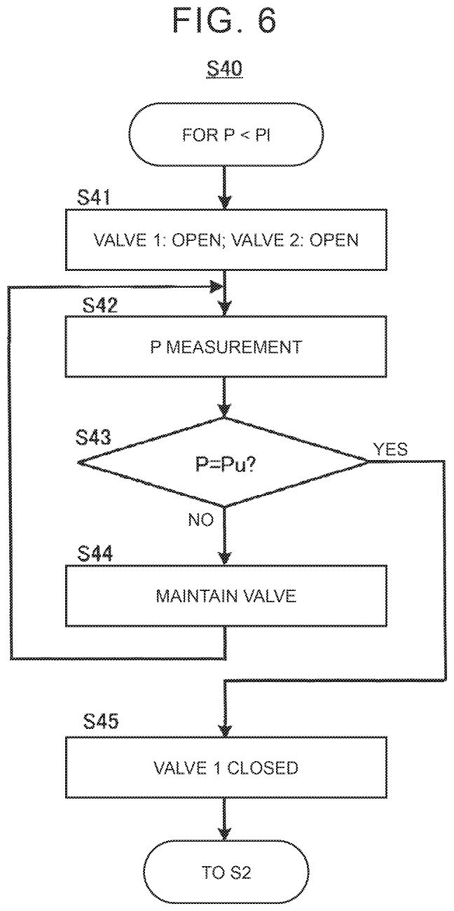

When P<Pl, the control S40 proceeds as shown in FIG. 6. This is the case when the internal pressure of the pressure vessel 11 falls below the pressure lower limit specified value Pl. At this time, both the switching valve 12a of the first line 12 and the switching valve 13a of the second line 13 are opened (process S41). According to this, the internal pressure of the pressure vessel 11 is reduced, and there is a pressure difference by an amount corresponding to the height of the liquid in the pressure vessel 11. Therefore, a part of the fluid vaporized by the vaporizer 16 branches at the position G, and gas flows toward the gas layer of the pressure vessel 11 as indicated by the straight arrow A in FIG. 1. This increases the internal pressure of the pressure vessel 11. Note that another part of the fluid vaporized by the vaporizer 16 is supplied to the supply target 1. Thereafter, P is measured by the pressure gauge 15 again (process S42), and the control device 20 determines P=Pu (process S43). If it is No in the process S43, since the internal pressure of the pressure vessel 11 has not reached the pressure upper limit specified value Pu, the switching valve 12a, 13a is maintained in the process S41 (process S44) and returns to the process S42. On the other hand, if it is Yes in the process S43, the internal pressure P has reached Pu, so that the switching valve 12a of the first line 12 is closed (process S45), and the process returns to the measurement S2 of P.

### 2. Effects

According to the present disclosure, when the internal pressure of the pressure vessel falls below the pressure lower limit specified value, the internal pressure of the pressure vessel is increased by the process S40. If the internal pressure of the pressure vessel exceeds the pressure upper limit specified value, the internal pressure of the pressure vessel is lowered by the process S30. As a result, the internal pressure of the pressure vessel can be appropriately controlled, and the internal pressure of the pressure vessel can be stably stored between the lower limit value and the upper limit value.

### 3. Other Forms

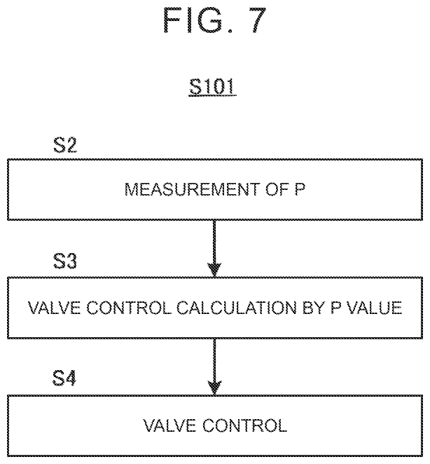

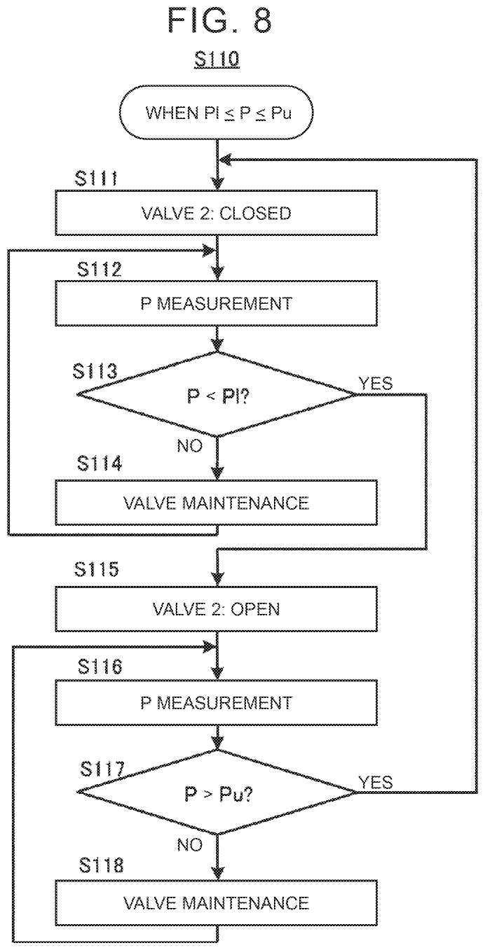

In another embodiment, the gas supply system 10 may be a gas supply system that does not include a switching valve 12a in the first line 12. As a result, the effect of the gas supply system 10 can be achieved, and the number of components of the system can be reduced and simplified. In the other embodiment, control is performed as in the control S101 as shown in FIG. 7. The measurement S2 of P constituting the control S101, the valve control calculation S3 based on the P, and the valve control S4 are the same as those described above. However, the valve control S4 performed here is advanced by the control S10 shown in FIG. 3 and the control S110 shown in FIG. 8. The details are as follows.

### For 3.1.P ≥Ps

If P≥Ps, the control S10 shown in FIG. 3 is used.

### When 3.2.Pl≤P≤Pu

If Pl≤P≤Pu, it is advanced by the control S110 as shown in FIG. 8. At this time, the switching valve 13a of the second line 13 is closed (process S111). As a result, the fluid in the gaseous state flows from the pressure vessel 11 through the second line 13, and the gas is supplied to the supply target 1. If this is continued, the internal pressure of the pressure vessel 11 decreases. Then, the internal pressure of the pressure vessel 11 is obtained by the pressure gauge 15 (process S112), and it is determined whether or not P≤Pl (process S113). If this is No, the vessel 11 is not yet below Pl, so that the valve condition of the process S111 is maintained (process S114) and the process S112 is returned. On the other hand, if it is Yes in the process S113, since P has fallen below Pl, the switching valve 13a of the second line 13 is changed to the open state (process 115). As a result, the gas can be supplied to the supply target 1 while increasing the internal pressure of the pressure vessel 11 as described in the control S40. Continuing this, the internal pressure of the pressure vessel 11 increases. Then, the internal pressure of the pressure vessel 11 is obtained by the pressure gauge 15 (process S116), and it is determined whether or not P>Pu (process S117). If this is No, the vessel 11 has not yet reached Pu, so that the valve condition of the process S115 is maintained (process S118) and the process S116 is returned. On the other hand, if it is Yes in the process S117, since P exceeds Pu, it returns to the process S111 to change the switching valve 13a of the second line 13 to the closed state, and thereafter, the above is repeated.

### When 3.3.Pu<P<Ps

If Pu<P<Ps, the process S111 of the control S110 shown in FIG. 8 may be started.

### For 3.4.P<Pl

If P<Pl, the process S115 of the control S110 shown in FIG. 8 may be started.

What is claimed is:

1. A gas supply system for supplying gas to a supply target from a gas-liquid mixed fluid stored in a pressure vessel, the gas supply system comprising:
a first line connected to a layer of the gas in the pressure vessel;
a second line connected to a layer of liquid in the pressure vessel and including a vaporizer in a middle of the second line, and merging into the first line downstream of the vaporizer;
a valve disposed between the pressure vessel and the vaporizer in the second line;
a pressure gauge for obtaining a pressure in the pressure vessel; and
a control device, wherein the control device receives pressure information from the pressure gauge, and opens the valve and performs control to supply the gas vaporized by the vaporizer in the second line from the first line to the pressure vessel when an internal pressure of the pressure vessel falls below a predetermined value.

2. A gas supply system for supplying gas to a supply target from a gas-liquid mixed fluid stored in a pressure vessel, the gas supply system comprising:
a first line connected to a layer of the gas in the pressure vessel;
a second line connected to a layer of liquid in the pressure vessel and including a vaporizer in a middle of the second line, and merging into the first line downstream of the vaporizer;
a valve disposed between the pressure vessel and the vaporizer in the second line;
a pressure gauge for obtaining a pressure in the pressure vessel; and
a control device, wherein the control device receives pressure information from the pressure gauge, and closes the valve and performs control to supply the gas from the first line to the supply target when an internal pressure of the pressure vessel exceeds a predetermined value.

3. The gas supply system according to claim 1, wherein the first line is also provided with a valve, and opening and closing of the valve is controlled by the control device.
